(19) United States
(12) Patent Application Publication
(10) Pub. No.: US 2022/0055578 A1
(43) Pub. Date: Feb. 24, 2022

(54) INTEGRATED MOBILE VEHICLE WASHING AND SERVICING FACILITY

(71) Applicant: CONRAC Solutions Parent, LLC, Renton, WA (US)

(72) Inventors: Matthew Reed Fairbanks, Renton, WA (US); Anthony Wayne Criddle, Renton, WA (US); Juan Villanueva, Elgin, IL (US); Justin Nobel Ovsak, Anchorage, AK (US)

(21) Appl. No.: 17/406,703

(22) Filed: Aug. 19, 2021

Related U.S. Application Data
(60) Provisional application No. 63/067,723, filed on Aug. 19, 2020.

(51) Int. Cl. B60S 3/06; B60S 3/00; B60S 5/02

(52) U.S. Cl. CPC B60S 3/063; B60S 5/02; B60S 3/002

(57) ABSTRACT

A modular mobile vehicle washing and servicing facility for washing, vacuuming, and performing other vehicle servicing functions. The modular facility includes automated car wash equipment housed in mobile containers designed for easy transport and quick set up to serve as a functionally and visually integrated facility. The facility includes a car wash bay housing the car wash equipment and first and second bay modules positioned adjacent the car wash bay and housing additional equipment to support the washing features of the car wash bay. A canopy extends over the car wash bay to provide cover and protect the car wash equipment.

### RELATED APPLICATION DATA

This application is a nonprovisional of claims the benefit under 35 U.S.C. § 119(e) of U.S. Provisional Patent Application No. 63/067,723, filed Aug. 19, 2020, the disclosure of which is incorporated by reference herein in its entirety.

### TECHNICAL FIELD

The field of the present disclosure relates generally to vehicle washing and servicing facilities, and in particular, to such facilities designed for easy assembly and disassembly to facilitate quick relocation and redeployment as desired. While the system can be part of a permanent solution, the system may also be useful for providing vehicle washing and servicing facilities on a temporary basis as needed.

### BACKGROUND

A conventional car wash facility typically includes a structure firmly constructed and supported on the ground, where the facility includes features such as a covered bay that houses rotating brushes, water and soap dispensing systems, drying systems, and other suitable components for washing a car. Some facilities may also include standalone stations away from the main washing bay with vacuums for cleaning a vehicle interior and/or air hose systems for pressurizing the vehicle tires as needed. One disadvantage of these conventional car wash and servicing facilities is that they are designed as fixed structures that cannot be easily moved and redeployed. In other words, the bays for washing and servicing cars and the associated equipment are all built into the ground and designed for structural stability. Accordingly, the design of such conventional facilities entirely lacks the opportunity for easy disassembly and convenient mobility. Moreover, these facilities lack the flexibility for quickly adding and/or replacing components as needed. In other words, since conventional systems include many fixed structures, it is difficult to modify or rearrange components as needed.

Accordingly, the present inventors have recognized a need for a vehicle servicing system designed for easy assembly, disassembly, and mobility. In addition, the present inventors have identified a need for a highly customizable modular system that accommodates multiple needs and is designed to be quickly assembled and deployed for either temporary or long term use. Additional aspects and advantages will be apparent from the following detailed description of example embodiments, which proceeds with reference to the accompanying drawings.

### BRIEF DESCRIPTION OF THE DRAWINGS

FIG. 1 illustrates an example embodiment of an integrated mobile vehicle servicing facility in accordance with one embodiment.

FIG. 2 is a front view of the facility of FIG. 1 illustrating interior features of the facility in accordance with one embodiment.

FIGS. 3 and 4 are perspective and top views, respectively, of the facility of FIG. 1 with the canopy and roof of the modules removed to illustrate various interior components of the facility.

FIGS. 5, 6A, and 6B collectively illustrate an improved bracket design for improving wire maintenance and performance of the overall system.

FIG. 7 illustrates another example embodiment of an integrated mobile vehicle servicing facility incorporating multiple bay modules and a fueling station in accordance with one embodiment.

### DETAILED DESCRIPTION OF EXAMPLE EMBODIMENTS

With reference to the drawings, this section describes various embodiments relating to a mobile vehicle washing, and servicing facility and its detailed construction and operation. Throughout the specification, reference to “one embodiment,” “an embodiment,” or “some embodiments” means that a described feature, structure, or characteristic may be included in at least one embodiment of the disclosed subject matter. Therefore, appearances of the phrases “in one embodiment,” “in an embodiment,” or “in some embodiments” in various places throughout this specification are not necessarily all referring to the same embodiment. Furthermore, the described features, structures, characteristics, and methods of operation may be combined in any suitable manner in one or more embodiments. In view of the disclosure herein, those skilled in the art will recognize that the various embodiments can be practiced without one or more of the specific details or with other methods, components, materials, or the like. In some instances, well-known structures, materials, or operations are not shown or not described in detail to avoid obscuring aspects of the embodiments.

The attached figures and the written description collectively illustrate an integrated mobile vehicle washing and servicing facility. In some embodiments, the mobile integrated vehicle servicing facility unit includes equipment for washing, vacuuming, and performing other vehicle servicing functions. For example, the facility may include automated car wash equipment, a water reclaim system, an air compressor and air hose system, a fluid dispensary system, a vacuum system, and a vehicle maintenance bay. As is further discussed in detail below, the system is designed to house various subsets of some or all components in mobile containers, such as ISO standard shipping containers or other suitable containers. The mobile containers are configured for transport and quick set-up as equipment installed with or without a foundation to serve as a functionally and visually integrated facility.

One potential benefit of the system described herein is that it provides for a complete and integrated servicing facility for washing and servicing (e.g., cleaning out and detailing the vehicle interior) vehicles. In addition, since the equipment is primarily housed within the mobile modules, the entire system is easily assembled, disassembled, and relocated as needed. In addition, any one of several modules can be installed in the facility, and modules can be upgraded quickly simply by removing one mobile module and replacing it with another as desired. In some embodiments as noted previously, the mobile modules are ISO standard shipping containers so the system would be easily transportable using existing forms of transportation used for shipping containers. In some instances, the system may require connections to external components, such as a power supply, a water supply, and/or a sewer connection. Preferably, the deployment site is selected such that these requirements are minimal, but some utility work may be necessary if the existing infrastructure (e.g., site-work, plumbing, and electrical capability) does not suit the site needs.

Another potential benefit of the disclosed system is that it provides a low-cost alternative to consolidated services sites that simply do not have the transaction volume to support a permanent facility, and/or provides interim solutions for existing permanent facilities that may need repair or are undergoing upgrades. Still another potential benefit of the disclosed system is that it provides ready-to-work equipment solutions for unplanned or seasonal needs. Finally, the modular aspect of the design allows for scalability in size and capacity to meet varying customer and market needs for both short-term and longer-term uses. Additional details of various components of the system is further described in detail with reference to the figures.

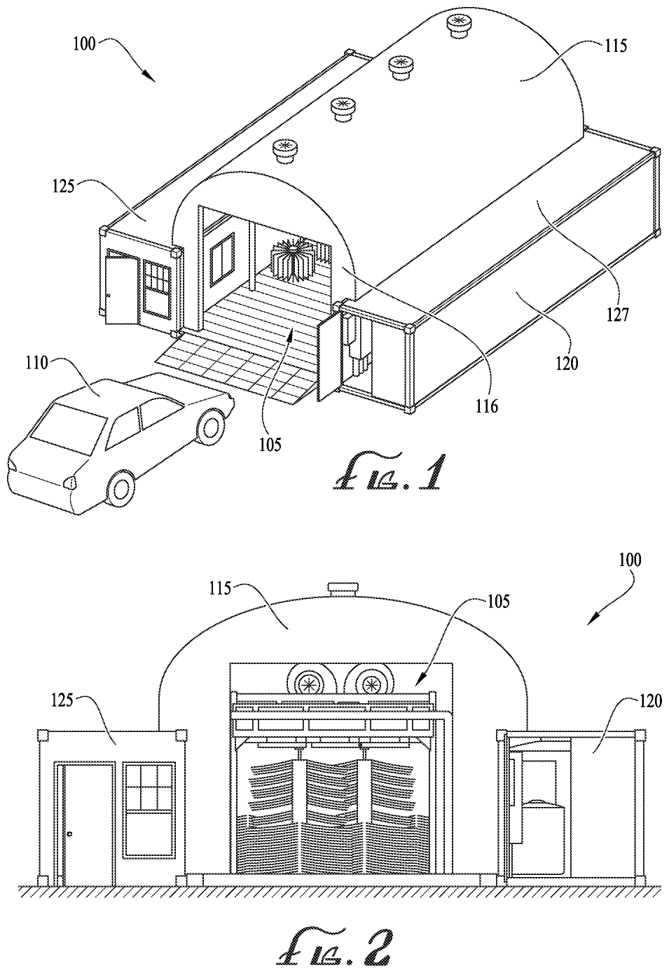

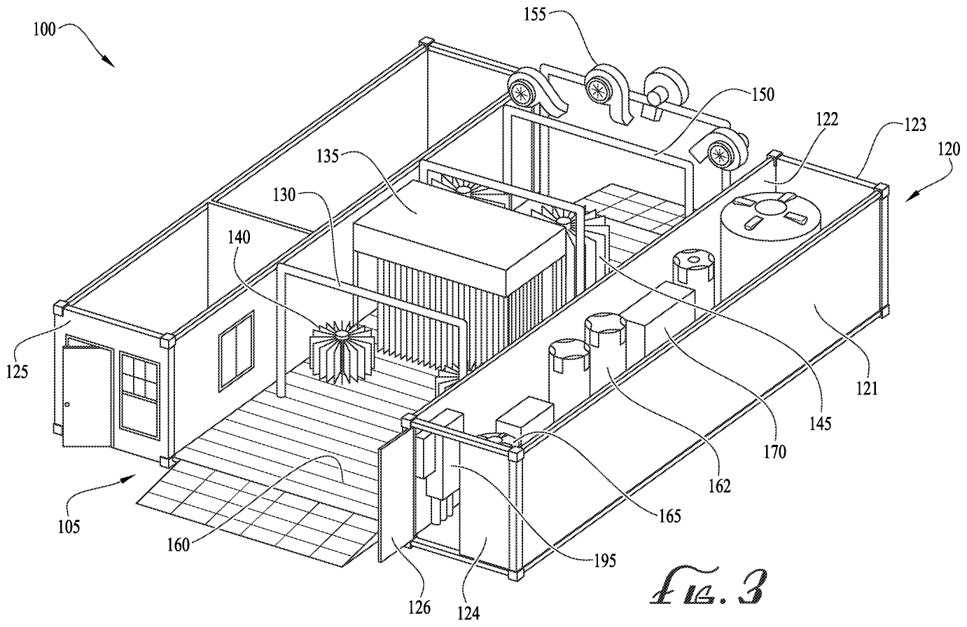

FIGS. 1-2 collectively illustrate an example embodiment of an integrated mobile vehicle washing and servicing facility 100. With reference to FIG. 1., the facility includes a car wash bay 105 that may be a pre-configured plumbing and washing system that contains equipment for washing a motor vehicle 110 automatically and complying with any applicable water reclaim requirements. The facility 100 includes a canopy 115 (e.g., a roof or other suitable cover system) extending over the car wash bay 105 to protect the operating car wash equipment therein from weather as well as providing additional visual appeal to the facility 100. The facility 100 may also include a separate prep station (not shown) where car cleaning, trash removal, or other servicing operations occur. The prep station may be housed in a separate bay module or housing container (similar to bay modules 120, 125) and include access to vacuum, windshield washer fluid dispenser, and other support equipment. As illustrated in FIG. 1, the car wash bay 105 and the canopy 115 may form the core components of the mobile vehicle washing and servicing facility 100.

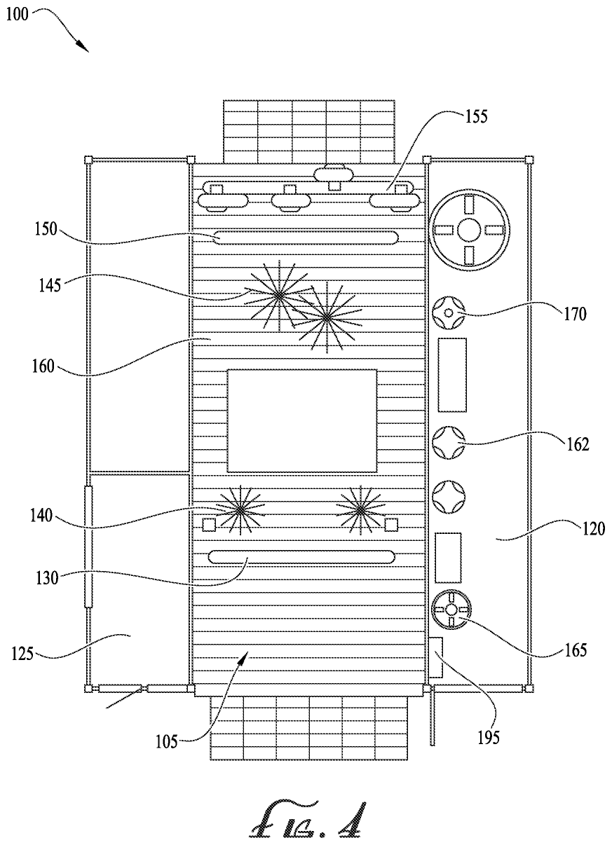

FIGS. 3 and 4 are perspective and top views, respectively, of the facility 100 of FIG. 1 with the canopy 115 and the roof of the bay modules 120, 125 removed to illustrate various interior components of the facility 100. With collective reference to FIGS. 3 and 4, the car wash bay 105 includes a front opening and a rear opening (see FIG. 3), and a tunnel defining a pathway for the vehicle 110 extending between the front and rear openings.

With reference to FIG. 3, the car wash bay 105 includes a water dispensing system housed therein and operable to deliver water onto the exterior surface of the vehicle 110. In some embodiments, the water dispensing system is removably coupled to a portable wash pad flooring system 160 further discussed below. In one embodiment, the water dispensing system may include a rain arch 130 extending across the washing bay and positioned adjacent the entrance or first opening, the rain arch 130 designed for supplying water onto an exterior surface of the vehicle 110 after it enters the washing bay. A cleaning agent dispenser (not shown) provides a cleaning agent (e.g., soap or other suitable agent) for washing the vehicle 110. The car wash bay 105 further includes a car wash mitter curtain system 135 including various strips of cloth or other suitable material, the mitter curtain system 135 positioned behind the rain arch 130. The mitter curtain system 135 and various brush assemblies 140, 145 are designed to scrub the exterior surface of the vehicle 110 and agitate the soap to provide a good lather for loosening dirt and debris as the vehicle 110 moves through the car wash bay 105. The water dispensing system may also include a fresh water rinse arch 150 positioned beyond or behind the curtain system 135 and the brush assemblies 140, 145 and before the rear opening of the car wash bay 105. The rinse arch 150 provides clean water to help remove soap, dirt, and debris from the vehicle 110. Finally, one or more dryer systems 155 are arranged adjacent the second opening of the car wash bay 105 to dry the vehicle 110 after the wash cycle is complete.

In some embodiments, the car wash bay 105 includes a portable wash pad flooring system 160 that may consist of a series of panels that are assembled to create a wash bay floor upon which the vehicle 110 rides, the wash bay floor extending between the first and second openings, and extending across and removably coupled with the bay modules 120, 125. The wash pad flooring system 160 may also incorporate a pre-fabricated plumbing system to reclaim water and contain the cleaning agent, dirt, and debris washed off the vehicles 110. The reclaimed water may be pumped through a filtration system where the water can be filtered, treated, stored (such as in water tanks 162), and reused in the car wash bay 105 as desired. This design may allow for EPA car wash compliance, reduced water expenses, and to help protect the environment. In some embodiments, the wash pad floor panels may be equipped with pre-drilled bolt holes, flanges, brackets or other devices for mounting any of the car wash equipment described above to the wash floor, and allowing for removal of the equipment for relocation of the facility when needed.

With particular reference to FIGS. 3 and 4, the facility 100 also includes two or more bay modules 120, 125 positioned on either side of the car wash bay 105. In some embodiments, the bay modules 120, 125 may each be an ISO standard shipping container unit designed for mobility. For example, with reference to bay module 120, the container unit may include an outer side wall 121, an inner side wall 122, a rear side wall 123 spanning between the outer and inner side walls 121, 122, and a front side wall 124 that may include one or more doors 126 to provide access to the equipment inside the bay module 120. A top wall or roof 127 (see FIG. 1) extends above and connects to the walls 121, 122, 123, 124, 126 to form an enclosed housing that is a standalone structure separate from the car wash bay. In some embodiments, bay module 125 may have a substantially similar configuration as bay module 120. In other embodiments, the bay module 125 may be outfitted slightly differently to provide a standard door and window along one of the side walls, such as for accommodating office space or a community space for personnel, as desired.

In some embodiments, the car wash bay 105 may lack side walls of its own, but the inner walls 122 of the first and second bay modules 120, 125 may instead form the side walls for the car wash bay 105 adjacent the tunnel pathway. For example, when the bay modules 120, 125 are coupled with the portable wash pad flooring system 160, the inner walls 121 bound the tunnel of the car wash bay 105 along opposite sides thereof to form an integrated structure, where the inner walls 121 separate the interiors of the bay modules 120, 125 from the interior of the car wash bay 105 as illustrated in FIG. 3.

In some embodiments, modules 120, 125 may be internally configured, plumbed and wired with mechanical and pump equipment, HVAC equipment, and other automated car wash support equipment to support the car wash bay 105. For example, in some embodiments, the module 120 may house one or more water tanks 162 with water lines (not shown) supplying water to the rain arches 130, 150, or other components of the car wash bay 105, a soap drum 165 operable for supplying soap to the car wash bay 105, water filtration equipment 170, and other suitable equipment to support the car wash bay 105. Bay module 125 may also be used to house equipment to support the car wash bay 105, or may be used as an office space to provide facilities for the employees, such as restrooms and break rooms. In some embodiments, bay module 125 may also provide extra storage and can be used to store car wash parts or the canopy system during transport. Preferably, all bay modules 120, 125 and the car wash bay 105 include appropriate lighting and ventilation systems as needed.

As noted previously, the facility 100 includes a canopy system 115 as illustrated in FIG. 1. The canopy 115 is illustrated covering the car wash bay 105, but it can be extended as needed to cover the bay modules 120, 125. For example, in one embodiment, the canopy 115 may be a detachable roof system having first and second outer ends 116, each end resting against and removably coupled to a top wall or roof 127 of the bay modules 120, 125. The canopy may include internal support structures (not shown) that rest against the ground or are removably coupled to the portable wash pad flooring system 160, the support structures extending upwardly therefrom to support the canopy 115 over the car wash bay 105. The canopy 115 may be a custom-built, easily-assembled system that allows for quick set up and take down for transport. For cold weather applications, the canopy system 115 may include or be configured to accommodate doors, curtains, or other suitable cover systems on each end of the wash tunnel over the first and second openings to shield the interior components of the car wash from the elements. The covers are designed to be opened to accommodate entrance/exit of the vehicle 110, and closed during the cleaning process or when no vehicles are present.

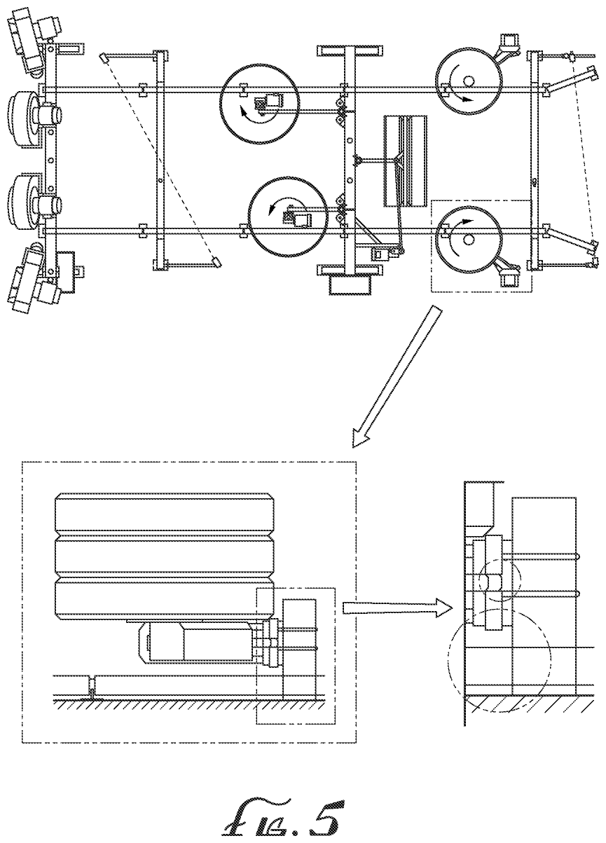

FIGS. 5, 6A, and 6B collectively illustrate details of a bracket 175 installed underneath the rocker panels 180 and retrofit to the rain arch 130 for improved performance. With collective reference to FIGS. 5, 6A, and 6B, the bracket 175 includes an opening 185 extending therethrough, the opening 185 allowing for wiring 190 to run through the rocker panels 180 to avoid impingement, dragging, and short circuits. The design reduces wear and tear on the equipment and allows for more effective cleaning.

In some embodiments, the car wash bay 105 may include an Internet-of-Things (IoT) monitoring system 195 (see FIG. 3) in communication with various components of the facility 100, where the monitoring system 195 is designed to receive data from various sensors to regulate the levels and use of various chemicals as needed. In one embodiment, the monitoring system 195 may include one or more chemical tank sensors (not shown) operable to monitor levels of cleaning chemical product stored in onsite containers. The sensors are designed to report quantities of stored cleaning chemicals available to the wash system. The system 195 may also include chemical flow meter sensors designed to consistently monitor and ensure that chemical pump injectors are supplying the same amount of cleaning chemical during each wash cycle to ensure that the car wash bay 105 delivers a quality cleaning job. In addition, since many of the components of the wash system are affected by the lubricity and causticity of the system's water, ensuring the application of safe and consistent amounts of cleaning chemicals helps optimize the usable lifespan of these components.

In some embodiments, the system 195 includes a wash cycle count sensor that tracks the number of wash cycles that the car wash bay 105 has undergone. This tracking information may be used to devise and tailor component maintenance schedules and help maintain optimum performance of the car wash bay 105. Data from the wash cycle count sensor may also be used to monitor overall usage trends for planning purposes.

In some embodiments, each of the sensors described above can be customized to provide alerts when certain parameters are triggered. For example, when chemical levels or wash cycles pass a predetermined threshold level, the monitoring system 195 may issue an alert to the determined recipient responsible for managing the system. Upon receipt of the alert, the recipient can then take appropriate remedial measures (e.g., order additional chemicals or schedule preventative maintenance) as necessary.

Each IoT gateway is assigned an individual IP address that can be remotely accessed in a secure manner. Remote access allows for transmission and reception of control signals to control the operational capacity of the car wash bay 105. In some embodiments, this activation control function can be automated or manually controlled as desired. In some embodiments, a redundant communication gateway can be installed to provide additional system reliability.

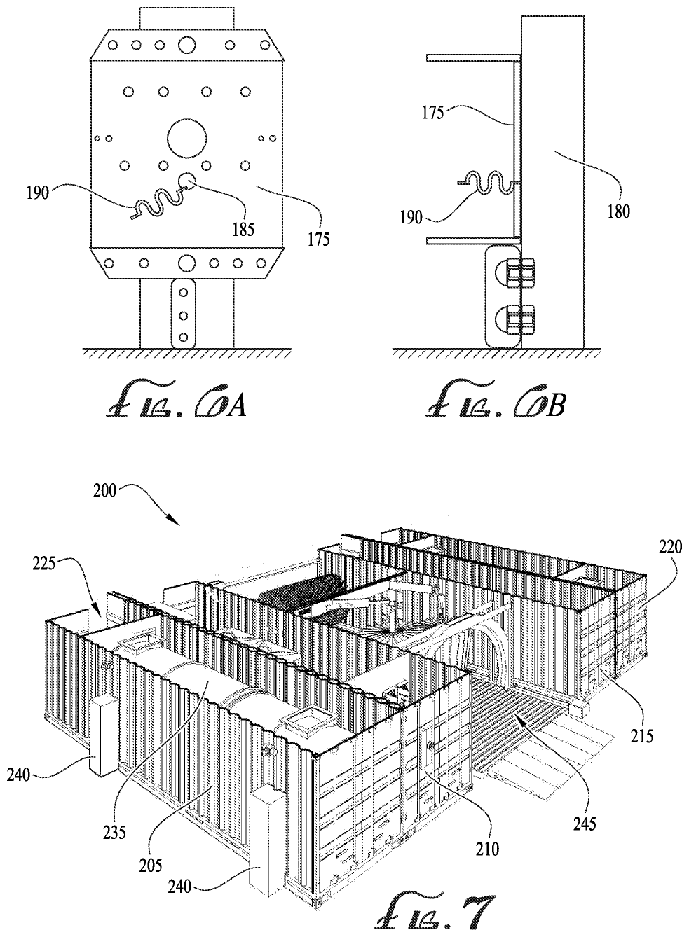

FIG. 7 illustrates another example embodiment of an integrated mobile vehicle servicing facility 200 incorporating multiple bay modules 205, 210, 215, 220 and a fueling station 225 along with a car wash bay 245 in accordance with one embodiment. Briefly, with reference to FIG. 7, the facility 200 includes a car wash bay 245 with similar components and functionality as the car wash bay 105 described previously. As illustrated in FIG. 7, the bay module 205 houses one or more fuel tanks 235 and supports dispenser units 240 for refueling vehicles as needed. In some embodiments, the fueling component (e.g., fuel tank 235 and dispenser unit 240) is pre-fabricated per individual needs for capacity, dispensing location, and dispensing capacity based on the anticipated volume of vehicles to be processed. Depending on various factors, such as client needs and vehicle flow patterns, the dispenser units 240 may be positioned on the long side of the bay module 205 as illustrated in FIG. 7, thereby providing a drive lane parallel to the wash tunnel and avoiding the fueling service blocking access to the washing service and vice versa. In other embodiments, the dispenser units 240 may instead be on the front or rear sides of the bay module 205 to allow fueling of a vehicle while it is in line to enter or having just left the wash tunnel. In other embodiments, other orientations may be possible. Preferably, the fuel tank 235 includes connectors and other necessary equipment to allow for on-site refueling, such as via a fuel tanker. In addition, the fuel tank 235 and fueling system may be designed and fabricated to meet all local fire code and all applicable above ground storage tank safety and environmental rules and regulations.

As described, the facilities 100, 200 are designed to allow personnel or other users to prep (clean, fuel, wash, etc.) vehicles quickly while efficiently using existing resources. The facility 100 is designed to serve the basic needs for this function in a low-cost environment with a temporary to semi-permanent timeline. The base system components are designed to be easily scalable in size and capacity to meet differing market needs. The integrated mobile vehicle fueling, washing and servicing facility may include any number of mobile modules equipped with vehicle fueling, washing and servicing equipment, such equipment being configured for assembly into an integrated vehicle fueling, washing and servicing facility capable of rapid deployment without a foundation. In some embodiments, the facilities may include additional bays that can serve as vehicle parking bays if desired. In other embodiments, the external walls of the bay modules may include a skin, durable panels, or other exterior cover for improved appearance in high visibility installations. The skin may be factory attached or transported inside and installed on-site to avoid damage.

It should be understood that the embodiments and foregoing description are meant for illustration purposes only and not intended to specifically limit the subject matter to the disclosed embodiments. In addition, while certain details may be described with reference to one embodiment, this description is not intended to be limited to that embodiment. One having ordinary skill in the art will be capable of combining the details of the various disclosed embodiments to arrive at an arrangement that may or may not have been illustrated or described.

It will be obvious to those having skill in the art that many changes may be made to the details of the above-described embodiments without departing from the underlying principles of the invention.

1. A modular vehicle washing and servicing facility comprising:
a car wash bay having a first opening and a second opening, the car wash bay defining a tunnel pathway for a vehicle extending between the first and the second openings;
a cleaning agent dispensing system operable to deliver a cleaning agent onto an exterior surface of the vehicle;
a water dispensing system housed within the car wash bay, the water dispensing system operable to deliver water onto the exterior surface of the vehicle;
a wash pad flooring system extending along a bottom portion of the tunnel pathway, the wash pad flooring system operable to collect water dispensed from the water dispensing system and the cleaning agent and debris washed off the vehicle;
a first bay module including a first side wall, an opposite second side wall, a third side wall spanning between the first and second side along a first end, a fourth side wall spanning between the first and second side along a second end, and a top wall extending above the first, second, third, and fourth side walls forming a self-contained housing separate from the car wash bay, the first bay module positioned adjacent a first side of the car wash bay;
a second bay module including a first side wall, an opposite second side wall, a third side wall spanning between the first and second side along a first end, a fourth side wall spanning between the first and second side along a second end, and a top wall extending above the first, second, third, and fourth side walls forming a self-contained housing separate from the car wash bay, the second bay module positioned adjacent a second side of the car wash bay; and
a canopy extending over and covering the car wash bay.

2. The modular vehicle washing and servicing facility of claim 1, wherein the first side wall of the first bay module is adjacent to the tunnel pathway along the first side of the car wash bay and forms a first wall of the tunnel pathway, and wherein the first side wall of the second bay module is adjacent to the tunnel pathway of the car wash bay and forms a second side wall of the tunnel pathway opposite the first wall.

3. The modular vehicle washing and servicing facility of claim 1, wherein the wash pad flooring system further comprises a series of panels that together form a wash bay floor, the series of panels extending between and removably coupled to each of the first bay module and the second bay module.

4. The modular vehicle washing and servicing facility of claim 3, wherein the canopy further includes a plurality of support structures removably coupled to the wash pad flooring system and extending upwardly therefrom to support the canopy.

5. The modular vehicle washing and servicing facility of claim 4, wherein the canopy further includes a first end removably coupled to the top wall of the first bay module, and a second end removably coupled to the top wall of the second bay module canopy to secure the canopy to the first and second bay modules.

6. The modular vehicle washing and servicing facility of claim 4, wherein the water dispensing system is removably coupled to the wash pad flooring system.

7. The modular vehicle washing and servicing facility of claim 1, wherein the wash pad flooring system further includes a plumbing system operable to reclaim water dispensed from the water dispensing system, wherein the reclaimed water is pumped through a filtration system and stored in a water storage tank for reuse by the water dispensing system.

8. The modular vehicle washing and servicing facility of claim 1, wherein the canopy further includes a first cover and a second cover, each of which being movable between an open condition and a closed condition, wherein the first cover extends over the first opening and the second cover extends over the second opening to shield an interior portion of the car wash bay.

9. The modular vehicle washing and servicing facility of claim 1, further comprising:
a mitter curtain system housed within the car wash bay and operable to agitate the cleaning agent on the exterior surface of the vehicle; and
one or more brush assemblies housed within the car wash bay and operable to agitate the cleaning agent on the exterior surface of the vehicle.

10. The modular vehicle washing and servicing facility of claim 9, the water dispensing system further comprising:
a first rain arch positioned between the first opening of the car wash bay and the mitter curtain system, the first rain arch operable to deliver water onto the exterior surface of the vehicle; and
a second rain arch positioned between the mitter curtain system and the second opening of the car wash bay, the second rain arch operable to deliver water onto the exterior surface of the vehicle to rinse the cleaning agent and debris from the exterior surface of the vehicle.

11. The modular vehicle washing and servicing facility of claim 10, further comprising a dryer system adjacent the second opening of the car wash bay, the dryer system operable to supply heat to the exterior surface of the vehicle to dry any remaining water.

12. The modular vehicle washing and servicing facility of claim 1, further comprising a water tank having water stored therein, the water tank having a water line connecting the water tank to the water dispensing system to supply water thereto, wherein the water tank is housed within one of the first bay module or the second bay module.

13. The modular vehicle washing and servicing facility of claim 12, wherein the wash pad flooring system further includes a plumbing system operable to reclaim water dispensed from the water dispensing system, the modular vehicle washing and servicing facility further comprising a filtration system housed within one of the first bay module or the second bay module, wherein the reclaimed water is pumped through the filtration system and stored in the water tank for reuse by the water dispensing system.

14. The modular vehicle washing and servicing facility of claim 13, further comprising a cleaning agent tank having the cleaning agent stored therein, wherein the cleaning agent tank is housed within one of the first bay module or the second bay module.

15. The modular vehicle washing and servicing facility of claim 14, further comprising a monitoring system including one or more sensors in operable communication with the water tank and the cleaning agent tank, the one or more sensors operable to determine a quantity of water in the water tank and a quantity of cleaning agent in the cleaning agent tank, and report the available quantities of water and cleaning agent.

16. The modular vehicle washing and servicing facility of claim 1, further comprising a flow meter in operable communication with the cleaning agent dispensing system, the flow meter operable to monitor a supplied amount of cleaning agent onto the exterior surface of the vehicle.

17. The modular vehicle washing and servicing facility of claim 1, further comprising a wash cycle counter operable to track a number of completing wash cycles.

18. The modular vehicle washing and servicing facility of claim 1, further comprising a third bay module forming a self-contained housing separate from the car wash bay and the first and second bay modules, the third bay module positioned adjacent one of the first or second bay modules, the third bay module housing a fuel tank therein, wherein a side wall of the third bay module further includes one or more fuel dispenser units for dispensing fuel to the vehicle.
